(19) United States
(12) Patent Application Publication
(10) Pub. No.: US 2008/0201903 A1
(43) Pub. Date: Aug. 28, 2008

(54) COUNTERBALANCE HINGE FOR VEHICLE CLOSURE

(75) Inventor: David M. Sovis, Harrison Township, MI (US)

Correspondence Address: BROOKS KUSHMAN P.C., 1000 TOWN CENTER, TWENTY-SECOND FLOOR, SOUTHFIELD, MI, 48075, US

(73) Assignee: Anderson-Cook, Inc., Clinton Township, MI (US)

(21) Appl. No.: 12/034,082

(22) Filed: Feb. 20, 2008

Related U.S. Application Data
(60) Provisional application No. 60/891,112, filed on Feb. 22, 2007.
(60) Provisional application No. 61/003,728, filed on Nov. 20, 2007.

(51) Int. Cl. E05F 1/12; E05F 1/08

(52) U.S. Cl. 16/290; 16/277

(57) ABSTRACT

A counterbalance hinge (20, 20′) for a vehicle closure includes a pivot and counterbalance assembly (44) having a cam (46) and a spindle (50) with a helical threaded connection biased by a spring (56,56′) that provides closure counterbalancing. In one embodiment the spring (56) is of the helical tension type and another embodiment has the spring (56′) of the helical compression type.

### CROSS-REFERENCE TO RELATED APPLICATIONS

This application claims the benefit of U.S. provisional application Ser. No. 60/891,112 filed Feb. 22, 2007 and Ser. No. 61/003,728 filed Nov. 20, 2007.

### BACKGROUND OF THE INVENTION

1. Field of the Invention

This invention provides a counterbalance hinge for use with a vehicle closure to provide counterbalancing of the closure during movement between closed and opened positions.

2. Background Art

Vehicle closures such as tailgates, liftgates, front engine compartment hoods, and rear deck lids etc. are most often pivotally supported by hinges and counterbalanced by gas springs whose extent of counterbalancing can be affected by temperature as well as age when gas pressure is lost. Furthermore, torque rods have also been used with hinges to provide counterbalancing through torsion induced in the torque rods during closure movement between closed and open positions, such torque rods are conventionally made of steel that adds weight to the vehicle.

### SUMMARY OF THE INVENTION

An object of the present invention is to provide an improved counterbalance hinge for a vehicle closure for use with a vehicle having an access opening that is selectively closed or opened by the closure.

In carrying out the above object, a vehicle closure counterbalance hinge constructed in accordance with the invention includes a vehicle bracket for mounting on the vehicle adjacent its access opening and also includes a closure bracket for mounting on the closure. A pivot and counterbalance assembly of the counterbalance hinge pivotally connects the vehicle bracket and the closure bracket for pivoting that supports the closure for movement about a pivot axis between closed and open positions with respect to the access opening of the vehicle. The pivot and counterbalance assembly includes a cam rotatively fixed with respect to one of the brackets and having a helical internal thread, and the pivot and counterbalance assembly also includes a spindle rotatively fixed with respect to the other bracket and having a helical external thread that is threaded into the helical internal thread of the cam. A spring of the pivot and counterbalance assembly has a central axis extending along the pivot axis and biasing the cam and spindle with respect to each other along the pivot axis to provide counterbalancing of the closure toward one of its positions with respect to the access opening of the vehicle.

In one usage, the closure counterbalance hinge is adapted to be mounted on a vehicle adjacent a lower extremity of a tailgate opening and the closure bracket is adapted to be mounted on a lower extremity of a tailgate that is pivotally moved between an upper closed position and a lower open position with respect to the tailgate opening and that is counterbalanced upwardly toward the upper closed position.

In another usage, the vehicle closure counterbalance hinge is adapted to be mounted on a vehicle adjacent an upper extremity of a liftgate opening and wherein the closure bracket is adapted to be mounted on an upper extremity of a liftgate that is pivotally moved between a lower closed position and an upper open position with respect to the liftgate opening and that is counterbalanced upwardly toward the upper open position.

The vehicle closure counterbalance hinge as discloses includes a helical spring which in one embodiment is a tension spring and in another embodiment is a compression spring.

In both the tension and compression spring embodiments, the cam is disclosed as including axial external splines, and the counterbalance hinge also includes a positioning tube rotatively fixed with respect to the one bracket and including axial internal splines that slidably receive the axial external splines of the cam to prevent cam rotation with respect to the one bracket while permitting axial movement between the cam and the spindle upon threading of their helical threads during counterbalance closure movement. Furthermore, the spindle extends through the positioning tube and has a distal positioning portion, and a brace is supported by the positioning tube and receives the distal positioning portion of the spindle to position the spindle with respect to the positioning tube.

The vehicle closure counterbalance hinge as disclosed includes an adjuster for adjusting the spring to control the extent of counterbalancing, and the counterbalance hinge may also include a power rotary actuator that is operated to assist in the counterbalancing of the closure. In addition, the vehicle closure counterbalance hinge as disclosed has the vehicle bracket provided with a connection to the spindle for preventing spindle rotation about the pivot axis while permitting limited pivoting of the pivot and counterbalance assembly about another axis transverse to the pivot axis to facilitate positioning of the counterbalance within the closure.

In the helical tension spring embodiment, the vehicle closure counterbalance hinge includes an elongated housing tube that receives the counterbalance and hinge assembly. This housing tube has a first end fixed to the one bracket and a second end spaced from its first end. The helical tension spring has one end connected to the cam and a second end connected to the second end of the housing tube to provide tensioning of the spring that provides the counterbalancing of the closure. An adjuster of this embodiment connects the second end of the spring to the second end of the housing tube. The adjuster as disclosed includes an adjuster cap rotatably supported on the second end of the housing tube and an adjuster screw connected to the second end of the spring and having a threaded connection to the adjuster cap whose rotation adjusts the tension of the spring to control the extent of counterbalancing. The helical tension spring embodiment also includes a positioning tube rotatively fixed with respect to the one bracket within the housing tube and including axial internal splines, and the cam includes axial external splines that are slidably received by the axial internal splines of the positioning tube to prevent cam rotation with respect to the one bracket while permitting axial movement between the cam and the spindle upon threading of their helical threads during counterbalanced closure movement.

In the helical compression spring embodiment, the vehicle closure counterbalance hinge has its helical compression spring provided with a first end seated against the one bracket and a second end spaced from its first end. The cam and spindle are received within the helical compression spring, and an adjuster connects the second end of the spring to the cam. The adjuster includes a plate that contacts the second end of the spring and also includes a threaded connection that extends between the plate and the cam to permit adjustment of the compression of the compression spring. The helical compression spring embodiment also includes a positioning tube received within the helical compression spring and rotatively fixed with respect to the one bracket and including axial internal splines, and the cam includes axial external splines that are slidably received by the axial internal splines of the positioning tube to prevent cam rotation with respect to the one bracket while permitting axial movement between the cam and the spindle upon threading of their helical threads during counterbalanced closure movement.

The objects, features and advantages of the present invention are readily apparent from the following detailed description of the preferred embodiments when taken in connection with the accompanying drawings.

### BRIEF DESCRIPTION OF THE DRAWINGS

FIG. 1 is a partial view of a vehicle which includes a tailgate supported for movement between an upper solid line closed position and a lower phantom line open position by a counterbalance hinge constructed in accordance with the present invention.

FIG. 2 is a partial view of a vehicle including a liftgate that is movable between a lower phantom line closed position and an upper solid line open position while supported by a counterbalance hinge constructed in accordance with the present invention.

FIG. 3 is a partial view that illustrates one embodiment of the counterbalance hinge when utilized with a tailgate as illustrated in FIG. 1.

FIG. 4 is a sectional perspective view of the one embodiment of the counterbalance hinge which includes a helical spring of the tension type.

FIG. 5 is a sectional view taken along the direction of line 5-5 in FIG. 4 to illustrate a connection between a vehicle mounted bracket and one end of a spindle of the counterbalance hinge.

FIG. 6 is an axial view taken along the direction of line 6-6 in FIG. 4 to illustrate a brace that positions the other end of the spindle.

FIG. 7 is a perspective view of another embodiment of the counterbalance hinge which includes a helical spring of the compression type.

FIG. 8 is an exploded perspective view of the compression spring embodiment of the counterbalance hinge.

FIG. 9 is a longitudinal sectional view of the compression spring embodiment of the counterbalance hinge.

FIG. 10 is a partial view of the tension spring embodiment illustrated as being power operated.

FIG. 11 is a partial view of the compression spring embodiment illustrated as being power operated.

### DETAILED DESCRIPTION OF THE PREFERRED EMBODIMENTS

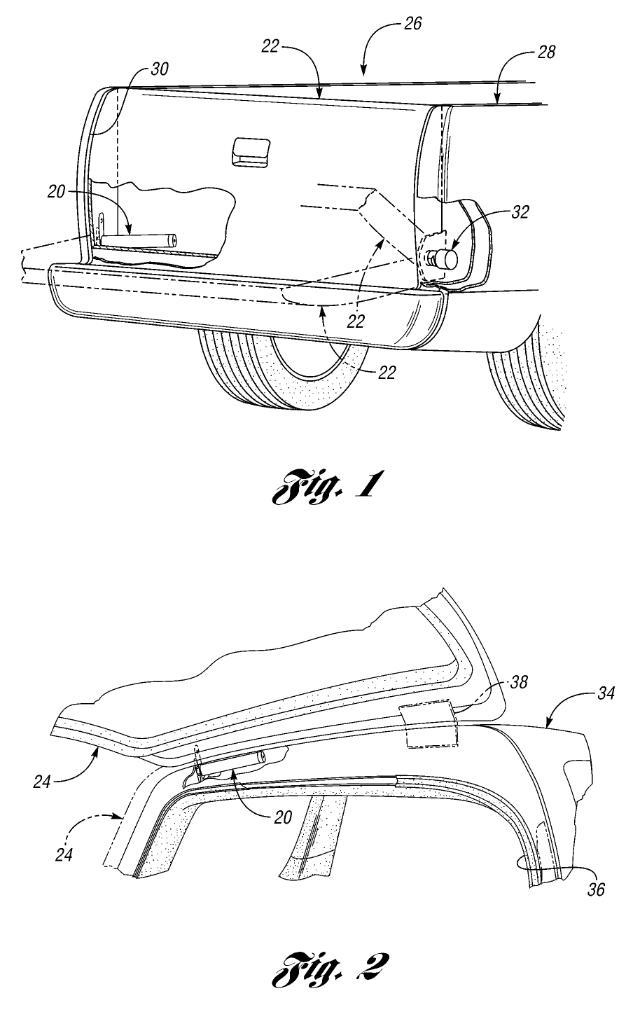

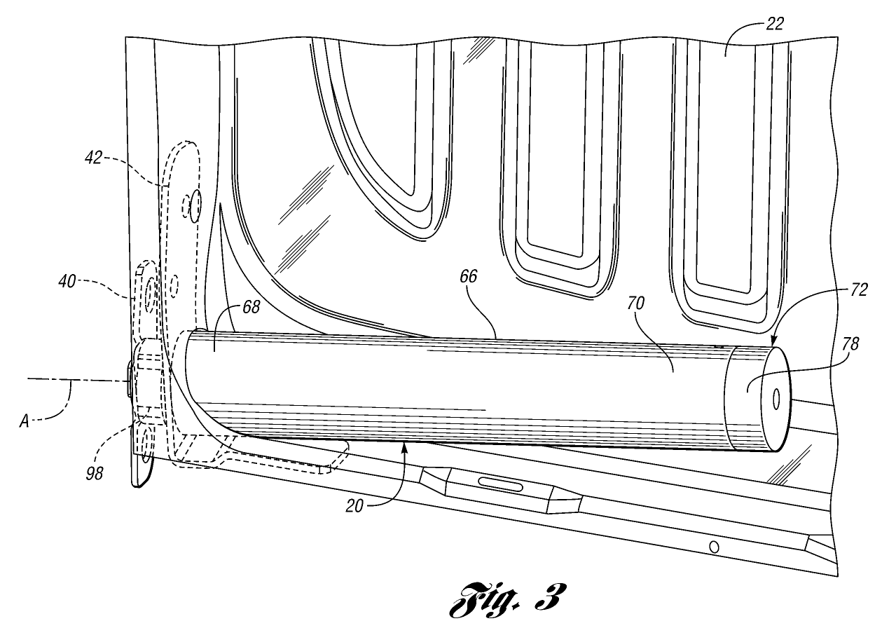

With reference to FIGS. 1 and 2, one embodiment of a vehicle closure counterbalance hinge 20 constructed in accordance with the present invention is illustrated as used with a tailgate 22 in FIG. 1 and a liftgate 24 in FIG. 2 which are usages for which the counterbalance hinge has particular utility even though it may also be utilized with other vehicle closures such as front hoods, rear deck lids, doors etc. In FIG. 1, the tailgate 22 is utilized with a truck 26 whose truck bed 28 has an access opening 30 that is selectively opened and closed by the tailgate 22. More specifically, any type of conventional tailgate hinge 32 and the counterbalance hinge 20 of the invention cooperate at the lower extremity of the access opening 30 and the lower extremity of the closed tailgate 22 in its upper closed position to provide mounting of the tailgate for pivotal movement between the horizontal open position shown by phantom line representation and the upper closed position. Furthermore, the van type vehicle 34 shown in FIG. 2 has a rear access opening 36 adjacent whose upper extremity the counterbalance hinge 20 of this invention cooperates with any type of conventional liftgate hinge 38 to support the liftgate 24 for pivotal movement between the lower closed position illustrated by phantom line representation and the upper open position illustrated by solid line representation.

In both the tailgate usage illustrated in FIG. 1 and the liftgate usage illustrated in FIG. 2, the counterbalance hinge 20 of the invention provides counterbalancing. More specifically, in the tailgate usage, the counterbalance hinge 20 resists downward movement of the tailgate 22 toward the horizontal open position and assists in upward movement toward the upper closed position. Similarly, in the liftgate usage shown in FIG. 2, the counterbalance hinge 20 assists in upward movement of the liftgate 24 to the upper open position and provides counterbalancing against the downward movement toward the closed lower position. While it is also possible to utilize the counterbalance hinge at both sides of either the tailgate or the liftgate, it has been found that a single counterbalance hinge is sufficient to provide adequate counterbalancing in conventional vehicles.

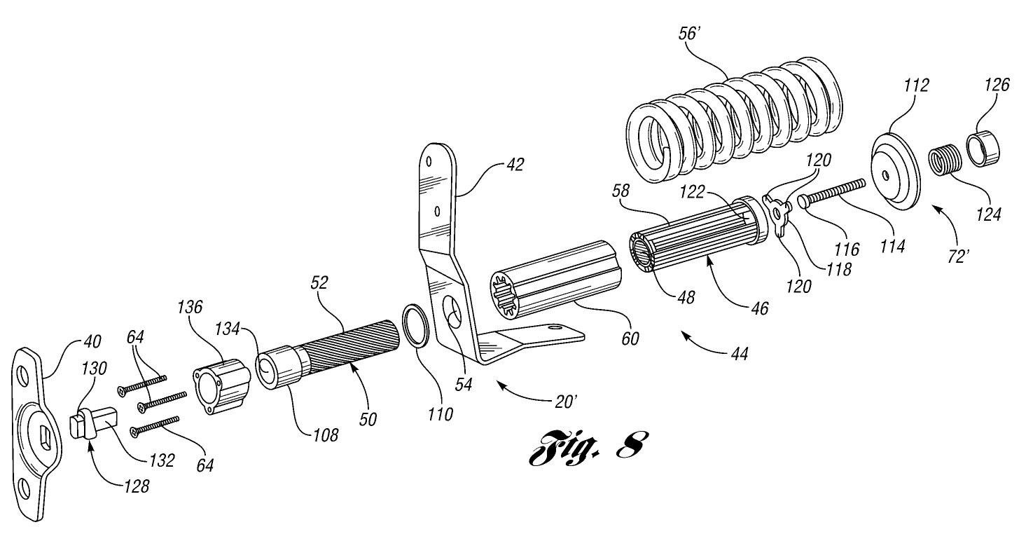

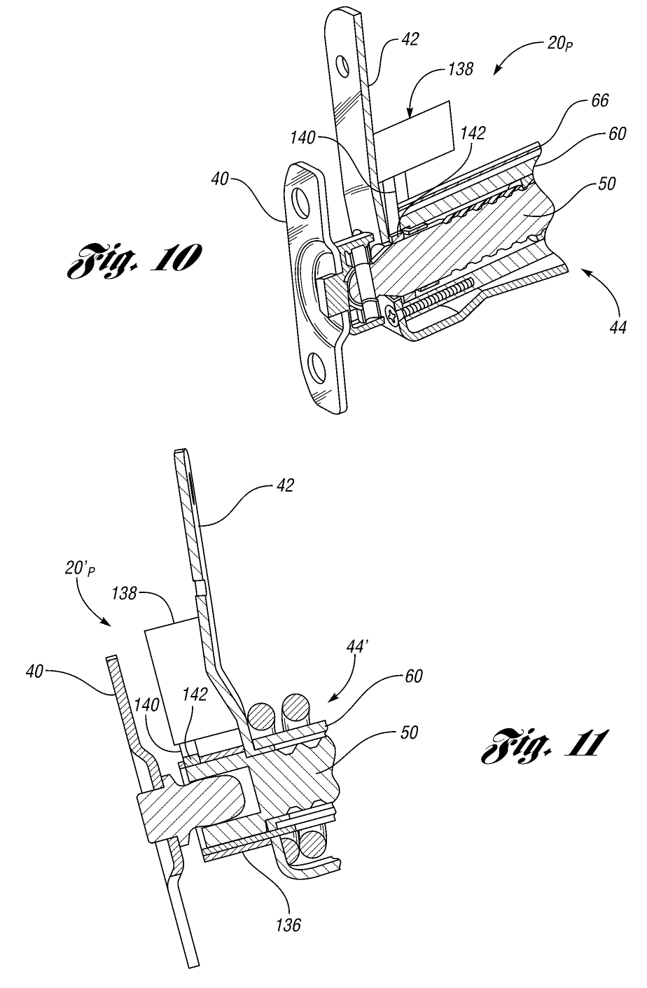

As it is hereinafter more fully described, the counterbalance hinge 20 is illustrated in FIGS. 3-6 as being of a tension spring type, while the counterbalance hinge 20′ illustrated in FIGS. 7-9 is illustrated as being of a compression spring type. Furthermore, FIGS. 10 and 11 respectively illustrate power operated versions 20p and 20′p that provide power assist to the tension and compression spring counterbalancing of the associated vehicle closure of whatever type. Also, while both the tension and compression springs 56 and 56′ are disclosed a being of the helical type, which is preferred, these springs may also be of the stacked washer spring type to provide the counterbalancing of the closure.

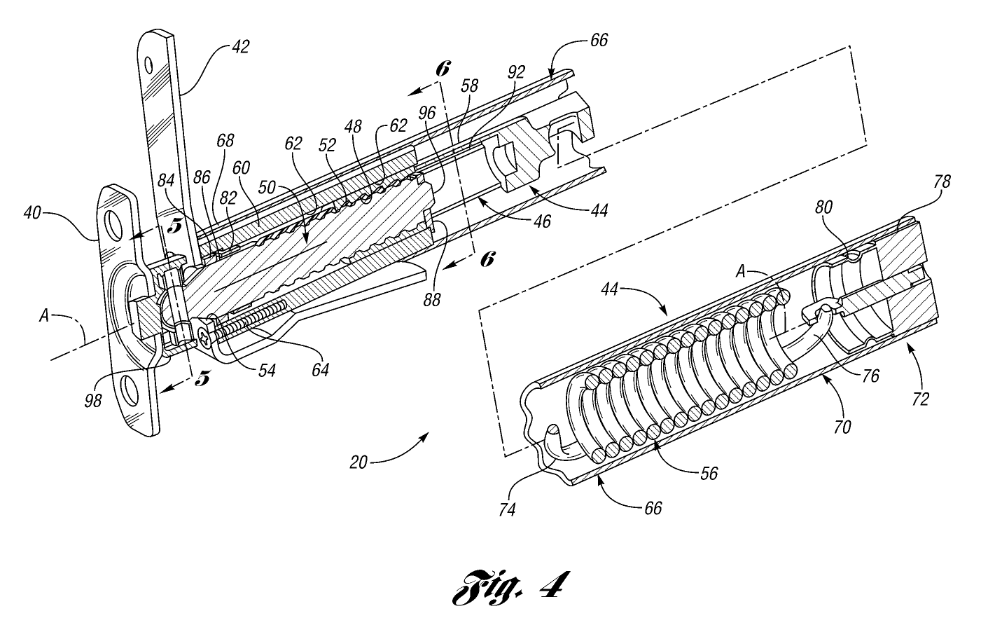

With reference to FIG. 3, the counterbalance hinge 20 illustrated includes a vehicle bracket 40 for mounting on the associated vehicle adjacent its access opening and also includes a closure bracket 42 for mounting on the associated vehicle closure. A pivot and counterbalance assembly shown in FIG. 4 supports the vehicle bracket 40 and the closure bracket 42 for pivoting that supports the associated closure for movement about a pivot axis A between closed and open positions with respect to the access opening of the associated vehicle. This pivot and counterbalance assembly 44 includes a cam 46 rotatively fixed with respect to one of the brackets, specifically the closure bracket 42 as illustrated, and having a helical internal thread 48. The pivot and counterbalance assembly 44 also includes a spindle 50 rotatively fixed with respect to the other bracket, the vehicle bracket 40 as illustrated, and having a helical external thread 52 that is threaded into the helical internal thread 48 of the cam 46. The spindle 50 extends through a hole 54 in the closure bracket 42 so as to provide support to the closure bracket for pivotal movement, and a spring 56 is illustrated as being of the helical tension type extending along the pivot axis A. The bias of spring 56 as is hereinafter more fully described biases the cam 46 and the spindle 50 with respect to each other along the pivot axis A to provide counterbalancing of the associated closure in the appropriate direction. More specifically, right hand or left hand threads for the cam internal thread 48 and the spindle external thread 50 can be utilized to provide the biasing in the appropriate direction.

With reference to FIGS. 4 and 6, the cam 46 includes axial external splines 58 and a positioning tube 60 shown in FIG. 4 is rotatively fixed with respect to the closure bracket 42 as illustrated. This positioning member 60 as shown in FIG. 6 includes axial internal splines 62 that slidably receive the axial external splines 58 of the cam 46 to prevent cam rotation with respect to the closure bracket 42 while permitting axial movement between the cam 46 and the spindle 50 upon threading of their helical threads 48 and 52 during counterbalanced closure movement. A plurality of elongated threaded fasteners 64 extend through the closure bracket 42 into axial holes in the positioning member 60 to provide the rotational fixing of the positioning member 60.

As shown in FIG. 4, the counterbalance hinge 20 also includes an elongated housing tube 66 that receives the counterbalance and hinge assembly 44. This housing tube 66 has a first end 68 fixed to the closure bracket 42 by the elongated threaded fasteners 64 whose threaded holes overlap the positioning member 60 and the housing tube. A second end 70 of the housing tube 66 is spaced from its first end and supports a spring adjuster 72. The helical tension spring 56 has one end 74 of a hook shape connected to the cam 46 and a second end 76 of a hook shape connected to the second end 70 of the housing tube 66 by the spring adjuster 72. More specifically, the spring adjuster 72 includes an adjuster cap 78 rotatably supported on the second end 70 of the housing tube 66, and the spring adjuster also includes an adjuster screw 80 threaded into the adjuster cap 78 and receiving the hooked second end 76 of the spring 56, such that rotation of the adjuster cap 78 adjusts the tension of the spring 56 to control the extent of counterbalancing provided through the threaded helical connection between the cam 46 and the spindle 50. A thrust bushing 82 fixed within the positioning member 60 and a thrust flange 84 on the spindle 50 are separated by a thrust washer pack 86 to counteract axial force applied to the spindle by the spring 56 providing the counterbalancing.

As shown in FIG. 6, a brace 88 is mounted on the end of the positioning tube 60 adjacent the cam 46 and has arms 90 that extend through associated axial slots 92 in the cam 46 to the positioning tube end. A central positioning opening 94 of the brace 88 receives a distal positioning portion 96 of the spindle 50 to position the spindle with respect to the positioning tube against radial movement.

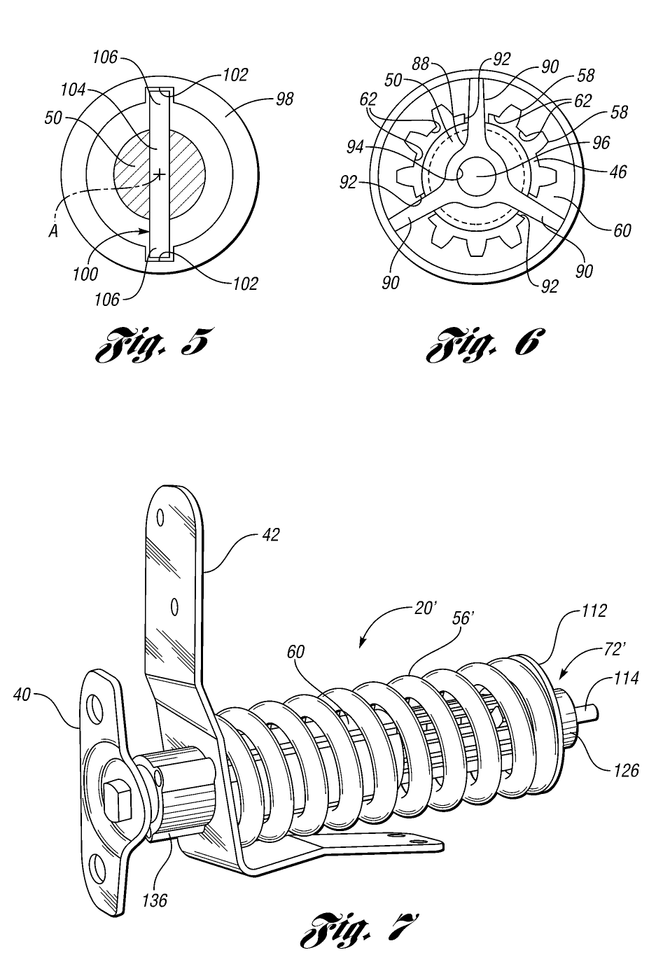

As illustrated in FIGS. 3 and 5, the vehicle bracket 40 includes a receptacle 98 including a spindle connection 100 shown in FIG. 5. More specifically, the receptacle 98 has diametrically opposite axial slots 102 in the receptacle 98 and a pin 104 through the end of the spindle 50 has ends 106 received by the axial slots to prevent rotation of the spindle about the pivot axis A while permitting limited pivoting of the counterbalance hinge about another axis transverse to the pivotal axis to facilitate positioning of the counterbalance hinge within the closure as illustrated in FIG. 3.

The compression spring embodiment 20′ of the counterbalance hinge is shown in FIGS. 7-9 and has many components the same as the tension spring embodiment except as will be noted such that much of the prior description is applicable and will not be repeated.

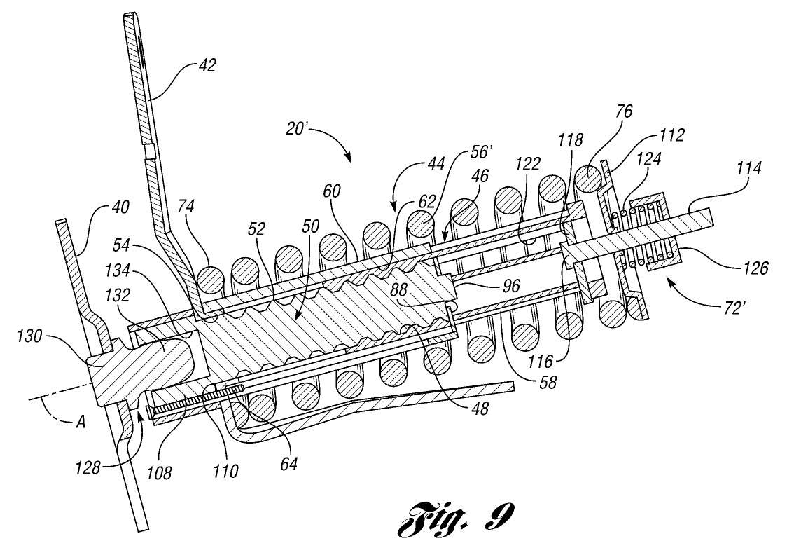

As best illustrated in FIG. 9, the compression spring 56′ of this embodiment of the counterbalance hinge 20′ has the one spring end 74 seated against the closure bracket 42 and has its second end 76 seated by the spring adjuster 72′. On the opposite side of the closure bracket 42 from the spring adjuster 72′ the spindle 50 has a thrust head 108 that engages a thrust washer pack 110 best shown in FIG. 8 for bearing against the closure bracket under the biasing of the spring. The second end 76 of spring 56′ is seated against a plate 112 of the spring adjuster 72′ which includes a threaded connector bolt 114 whose end 116 secures a connector brace 118 having arms 120 that extend through axial slots 122 in the adjacent end of the cam 46. An adjuster spring 124 extends between the plate 112 and a threaded adjuster cap 126 that is threaded onto the bolt connector. The adjuster 72′ thus provides a connection between the second spring end and the cam 46 and is adjustable to adjust the spring and thereby control the extent of counterbalancing provided by the counterbalance hinge.

The cam 46, spindle 50 and position member 60 as shown in FIG. 9 are received within the compression spring 56′ which provides the axial biasing of the cam and spindle relative to each other.

As shown in FIGS. 8 and 9, a connector 128 has an end 130 mounted on the vehicle bracket 40 and has a connector projection 132 received within a hole 134 in the spindle thrust head 108. The projection 132 and hole 140 are configured to prevent rotation of the spindle 50 about the pivot axis A while permitting limited pivoting about an axis transverse to the pivot axis in order to provide a connection that facilitates positioning of the counterbalance hinge within the associated closure in the same manner previously described. Also, as shown in FIG. 8, a cover 136 receives the spindle thrust head 108 and is secured by the threaded fasteners 64 that extend through associated holes in the closure bracket 42 into the positioning member 60 to prevent its rotation with respect to the closure bracket in the same manner previously described.

With reference to FIG. 10, a power operated embodiment 20ₚ includes a power rotary actuator 138 mounted on the closure bracket 42 and having an output gear 140 meshed with gear teeth 42 on the thrust flange 84 of spindle 50. This power rotary actuator 138 will most likely be an electric motor that drives a reduction gear train for driving the output gear 140. Since the spindle 50 supporting the thrust flange gear teeth 142 cannot rotate, the rotary actuator 138 back drives the closure bracket 42 to assist the spring bias in counterbalancing the associated closure with which the counterbalance hinge is used.

As illustrated in FIG. 10, a power operated embodiment 20′ₚ of the compression spring version has the power rotary actuator 138 mounted on the opposite side of the closure bracket 42 as the tension spring embodiment of FIG. 10. The actuator output gear 140 is meshed with gear teeth 142 on the spindle thrust head 108 extending through a suitable hole in the cover 136 to provide the back driving that assists the spring in counterbalancing the associated closure.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A counterbalance hinge for a vehicle closure for use with a vehicle having an access opening, the counterbalance hinge comprising:
a vehicle bracket for mounting on the vehicle adjacent its access opening;
a closure bracket for mounting on the closure; and
a pivot and counterbalance assembly that pivotally connects the vehicle bracket and the closure bracket for pivoting that supports the closure for movement about a pivot axis between closed and open positions with respect to the access opening of the vehicle, the pivot and counterbalance assembly including a cam rotatively fixed with respect to one of the brackets and having a helical internal thread, the pivot and counterbalance assembly also including a spindle rotatively fixed with respect to the other bracket and having a helical external thread that is threaded into the helical internal thread of the cam, and a spring having a central axis extending along the pivot axis and biasing the cam and spindle with respect to each other along the pivot axis to provide counterbalancing of the closure toward one of its positions with respect to the access opening of the vehicle.

2. A vehicle closure counterbalance hinge as in claim 1 wherein the vehicle bracket is adapted to be mounted on a vehicle adjacent a lower extremity of a tailgate opening and wherein the closure bracket is adapted to be mounted on a lower extremity of a tailgate that is pivotally moved between an upper closed position and a lower open position with respect to the tailgate opening and that is counterbalanced upwardly toward the upper closed position.

3. A vehicle closure counterbalance hinge as in claim 1 wherein the vehicle bracket is adapted to be mounted on a vehicle adjacent an upper extremity of a liftgate opening and wherein the closure bracket is adapted to be mounted on an upper extremity of a liftgate that is pivotally moved between a lower closed position and an upper open position with respect to the liftgate opening and that is counterbalanced upwardly toward the upper open position.

4. A vehicle closure counterbalance hinge as in claim 1 wherein the spring is a helical spring.

5. A vehicle closure counterbalance hinge as in claim 4 wherein the helical spring is a tension spring.

6. A vehicle closure counterbalance hinge as in claim 4 wherein the helical spring is a compression spring.

7. A vehicle closure counterbalance hinge as in claim 1 wherein the cam includes axial external splines, and further including a positioning tube rotatively fixed with respect to said one bracket and including axial internal splines that slidably receive the axial external splines of the cam to prevent cam rotation with respect to the one bracket while permitting axial movement between the cam and the spindle upon threading of their helical threads during counterbalanced closure movement.

8. A vehicle closure counterbalance hinge as in claim 7 wherein the spindle extends through the positioning tube and has a distal positioning portion, and a brace supported by the positioning tube and receiving the distal positioning portion of the spindle to position the spindle with respect to the positioning tube.

9. A vehicle closure counterbalance hinge as in claim 1 further including an adjuster for adjusting the spring to control the extent of counterbalancing.

10. A vehicle closure counterbalance hinge as in claim 1 further including a power rotary actuator that is operated to assist in the counterbalancing of the closure.

11. A vehicle closure counterbalance hinge as in claim 1 wherein the vehicle bracket includes a connection to the spindle for preventing spindle rotation about the pivot axis while permitting limited pivoting of the pivot and counterbalance assembly about another axis transverse to the pivot axis to facilitate positioning of the counterbalance hinge within the closure.

12. A vehicle closure counterbalance hinge as in claim 1 further including an elongated housing tube that receives the counterbalance and hinge assembly, the housing tube having a first end fixed to said one bracket and a second end spaced from its first end, the spring being a helical tension spring having one end connected to the cam and a second end connected to the second end of the housing tube to provide tensioning of the spring that provides the counterbalancing of the closure.

13. A vehicle closure counterbalance hinge as in claim 12 further including an adjuster that connects the second end of the spring to the second end of the housing tube.

14. A vehicle closure counterbalance hinge as in claim 13 wherein the adjuster includes an adjuster cap rotatably supported on the second end of the housing tube and an adjuster screw connected to the second end of the spring and having a threaded connection to the adjuster cap whose rotation adjusts the tension of the spring to control the extent of counterbalancing.

15. A vehicle closure counterbalance hinge as in claim 12 further including a positioning tube rotatively fixed with respect to said one bracket and including axial internal splines, and the cam including axial external splines that are slidably received by the axial internal splines of the positioning tube to prevent cam rotation with respect to the one bracket while permitting axial movement between the cam and the spindle upon threading of their helical threads during counterbalanced closure movement.

16. A vehicle closure counterbalance hinge as in claim 1 the spring is a helical compression spring having a first end seated against the one bracket and a second end spaced therefrom, the cam and spindle being received within the helical compression spring, and an adjuster that connects the second end of the spring to the cam.

17. A vehicle closure counterbalance hinge as in claim 16 wherein the adjuster includes a plate that contacts the second end of the spring and also includes a threaded connection that extends between the plate and the cam to permit adjustment of the compression of the compression spring.

18. A vehicle closure counterbalance hinge as in claim 16 further including a positioning tube rotatively fixed with respect to said one bracket and including axial internal splines, and the cam including axial external splines that are slidably received by the axial internal splines of the positioning tube to prevent cam rotation with respect to the one bracket while permitting axial movement between the cam and the spindle upon threading of their helical threads during counterbalanced closure movement.

19. A counterbalance hinge for a vehicle closure for use with a vehicle having an access opening, the counterbalance hinge comprising:
a vehicle bracket for mounting on the vehicle adjacent its access opening;
a closure bracket for mounting on the closure; and
a pivot and counterbalance assembly that pivotally connects the vehicle bracket and the closure bracket for pivoting that supports the closure for movement about a pivot axis between closed and open positions with respect to the access opening of the vehicle, the pivot and counterbalance assembly including a cam rotatively fixed with respect to one of the brackets and having a helical internal thread, the pivot and counterbalance assembly also including a spindle rotatively fixed with respect to the other bracket and having a helical external thread that is threaded into the helical internal thread of the cam, a positioning tube rotatively fixed with respect to said one bracket and including axial internal splines, the cam including external axial splines that are slidably received by the axial internal splines of the positioning tube to prevent cam rotation with respect to the one bracket, and a helical spring having a central axis extending along the pivot axis and biasing the cam and spindle with respect to each other along the pivot axis to provide counterbalancing of the closure toward one of its positions with respect to the access opening of the vehicle.

20. A counterbalance hinge for a vehicle closure for use with a vehicle having an access opening, the counterbalance hinge comprising:
a vehicle bracket for mounting on the vehicle adjacent its access opening;
a closure bracket for mounting on the closure; and
a pivot and counterbalance assembly that pivotally connects the vehicle bracket and the closure bracket for pivoting that supports the closure for movement about a pivot axis between closed and open positions with respect to the access opening of the vehicle, the pivot and counterbalance assembly including a cam rotatively fixed with respect to one of the brackets and having a helical internal thread, the pivot and counterbalance assembly also including a spindle rotatively fixed with respect to the other bracket and having a helical external thread that is threaded into the helical internal thread of the cam, a positioning tube rotatively fixed with respect to said one bracket and including axial internal splines, the cam including external axial splines that are slidably received by the axial internal splines of the positioning tube to prevent cam rotation with respect to the one bracket, a helical spring having a central axis extending along the pivot axis and biasing the cam and spindle with respect to each other along the pivot axis to provide counterbalancing of the closure toward one of its positions with respect to the access opening of the vehicle, and an adjuster for adjusting the spring to control the extent of counterbalancing provided.
